(19) United States
(12) Patent Application Publication
(10) Pub. No.: US 2011/0139268 A1
(43) Pub. Date: Jun. 16, 2011

(54) Mounting System

(76) Inventor: Richard E. Scallen, Gillette, WY (US)

(21) Appl. No.: 12/638,928

(22) Filed: Dec. 15, 2009

(51) Int. Cl. F16L 55/07

(52) U.S. Cl. 137/315.01; 137/802

(57) ABSTRACT

A mounting system made up of a valve isolation assembly comprising first and second inlet ports and first and second outlet ports along with a pair of crossable pressure lines made up of first and second pipes. The first and second pipes respectively define first and second upper ends and first and second lower ends. The first and second pipes also define first and second middle portions. The upper ends of each first and second pipe are operably coupled to the first and second inlet ports of the valve isolation assembly. In one embodiment the first and second middle portions each define a quarter right-handed helix turn. In another embodiment the first and second middle portions each define a quarter left-handed helix turn.

### CROSS-REFERENCE TO RELATED APPLICATIONS

Not applicable.

### STATEMENT REGARDING FEDERALLY SPONSORED RESEARCH OR DEVELOPMENT

Not Applicable.

### FIELD OF THE INVENTION

This invention relates to a mounting system comprising at least one valve assembly and a pair of crossable pressure lines.

### BACKGROUND OF THE INVENTION

In the hydrocarbon extraction and distribution industry it is important to be able to measure flow rates of hydrocarbon gas or liquid at remote locations in the distribution systems. A common method of measuring hydrocarbon flow in a pipe requires monitoring differential pressure across an orifice plate inserted into a flow metering pipe and correlating this differential using known relationships to compute the rate of flow in the pipe.

For example, a gas flow computer calculates gas flow rate based on the differential pressure making corrections for such parameters as temperature and gas composition. Hydrocarbon gas flow in a gas stream typically contains a mix of various hydrocarbon gases of different specific gravities along with non-hydrocarbon gases such as nitrogen and carbon dioxide. Therefore the gas flow computer also typically requires the entry of mole percents for each gas component.

Apart from the complexities involved in making hydrocarbon flow calculations there is a need to operationally connect flow computers such as gas flow computers and differential pressure sensors to a flow metering pipe at remote sites in a hydrocarbon distribution system. Making direct connections between the flow metering pipe and the flow computer can be difficult and time consuming. Therefore, there is a need for equipment that permits direct connections between the flow metering pipe and the flow computer.

### SUMMARY OF THE INVENTION

A mounting system made up of a valve isolation assembly comprising first and second inlet ports and first and second outlet ports along with a pair of crossable pressure lines made up of first and second pipes. The first and second pipes respectively define first and second upper ends and first and second lower ends. The first and second pipes also define first and second middle portions. The upper ends of each first and second pipe are operably coupled to the first and second inlet ports of the valve isolation assembly. In one embodiment the first and second middle portions each define a quarter right-handed helix turn. In another embodiment the first and second middle portions each define a quarter left-handed helix turn.

### BRIEF DESCRIPTION OF THE DRAWINGS

FIG. 1 is a perspective environmental view of the mounting system employing a pair of crossable rigid pressure lines with each having a quarter right-handed helical twist therein, according to the present invention.

FIG. 2 is a perspective environmental view of the mounting system employing a pair of crossable rigid pressure lines arranged in parallel configuration with each pressure line having a quarter right-handed helical twist therein, according to the present invention.

FIG. 3 shows an exploded view of the mounting system according to the present invention.

FIG. 4 shows a partial side view of the mounting system of FIG. 2.

FIG. 5 shows a partial side view of the mounting system of FIG. 1.

FIG. 6 shows a front view of the mounting system employing a pair of crossable rigid pressure lines with each having a quarter right-handed helical twist therein, according to the present invention.

FIG. 7 shows a front vertical view of a pair of crossable rigid pressure lines with each having a quarter right-handed helical twist therein, according to the present invention.

FIG. 8 shows a rear vertical view of the pair of crossable rigid pressure lines shown in FIG. 7.

FIG. 9 shows a perspective bottom view of the pair of crossable rigid pressure lines shown in FIG. 7.

FIG. 10 shows a perspective bottom view of the pair of crossable rigid pressure lines shown in FIG. 8.

FIG. 11 shows a front vertical view of a pair of crossable rigid pressure lines with each having a quarter left-handed helical twist therein, according to the present invention.

FIG. 12 shows a rear vertical view of the pair of crossable rigid pressure lines shown in FIG. 11.

FIG. 13 shows a perspective bottom view of the pair of crossable rigid pressure lines shown in FIG. 11.

FIG. 14 shows a perspective bottom view of the pair of crossable rigid pressure lines shown in FIG. 12.

FIG. 15 is a perspective environmental view of the mounting system employing a pair of crossable rigid pressure lines with each having a quarter left-handed helical twist therein, according to the present invention.

FIG. 16 shows a schematic according to the present invention.

FIG. 17 shows a schematic layout of an exemplar of an isolation valve assembly.

FIGS. 18A and 18B show a table (Table 1).

### DETAILED DESCRIPTION

This invention is directed to a mounting system 100 comprising a valve isolation assembly 120 and a pair of crossable rigid pressure lines 130. More specifically, the invention is a mounting system 100 which enables fluid communication between, for example, a meter tube 160 and a valve isolation assembly 120.

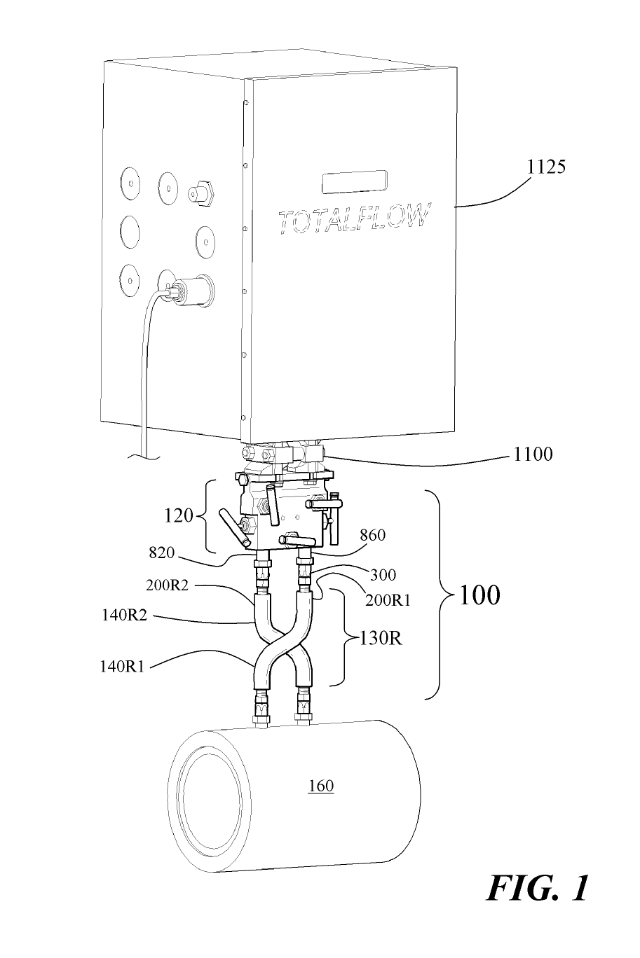

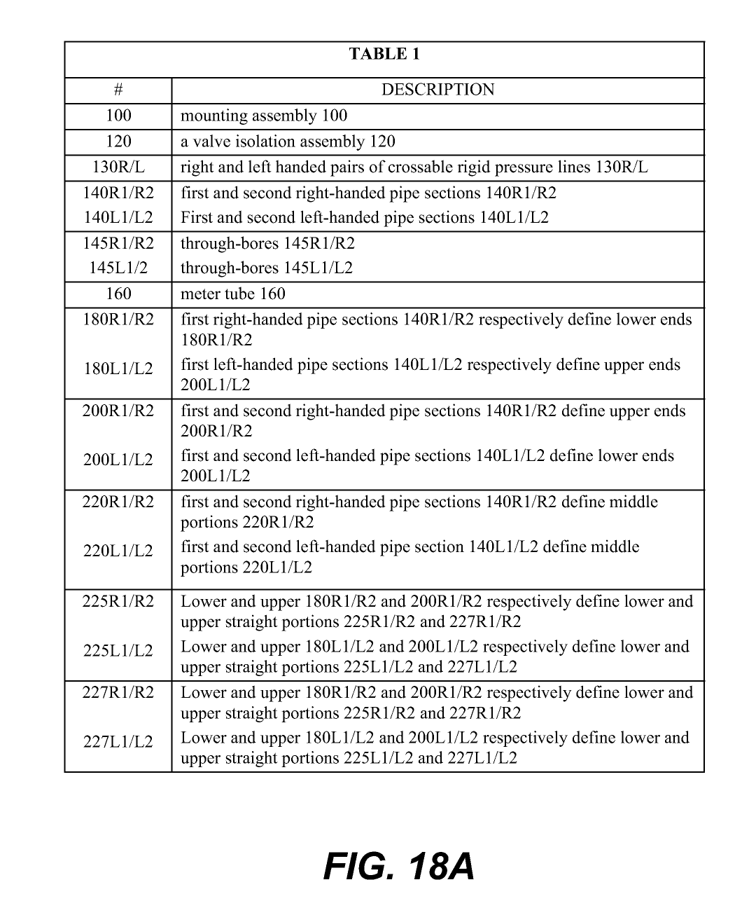

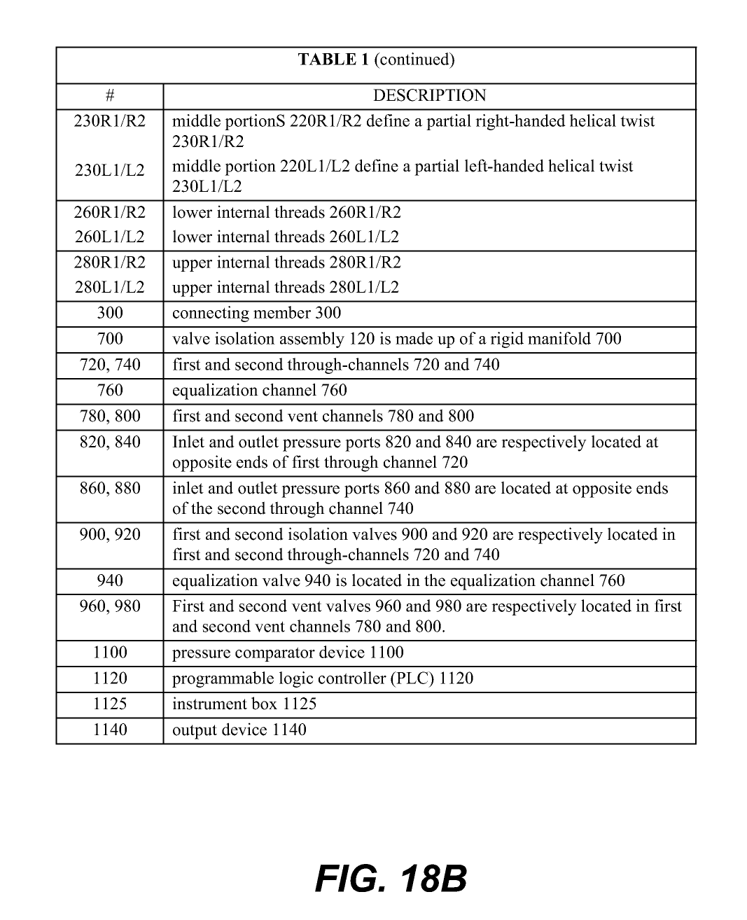

It will be understood that the terms “upper and lower”, “front and rear”, and “top and bottom” are used for convenience to describe relative directional reference in the common orientation of mounting system 100 as shown, for example, in FIG. 1. However, it will be appreciated that mounting system 100 can be operated in other orientations. A summary of the component parts that make up various embodiments of the mounting system 100 are listed in Table 1 (see FIGS. 18A and 18B).

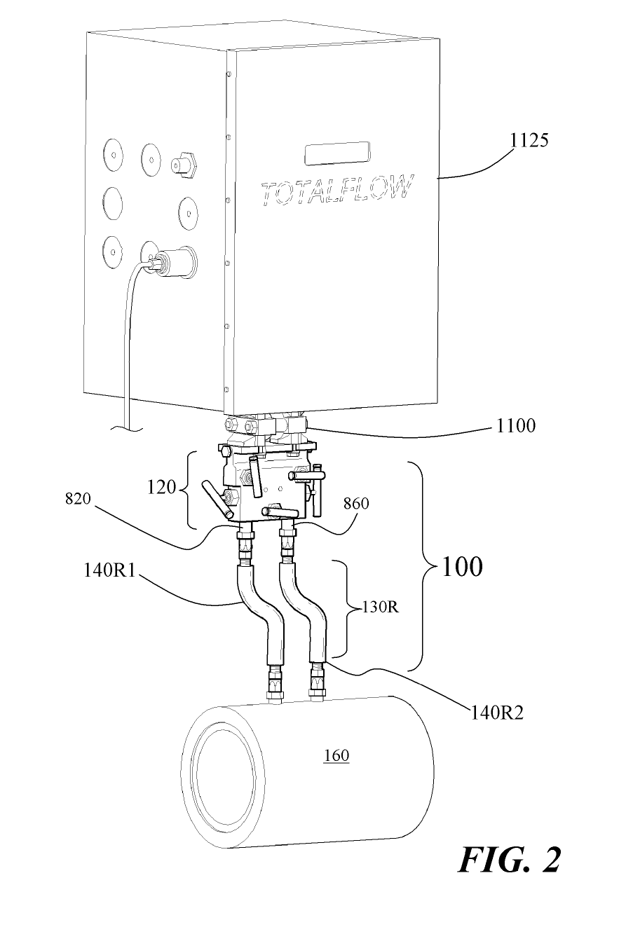

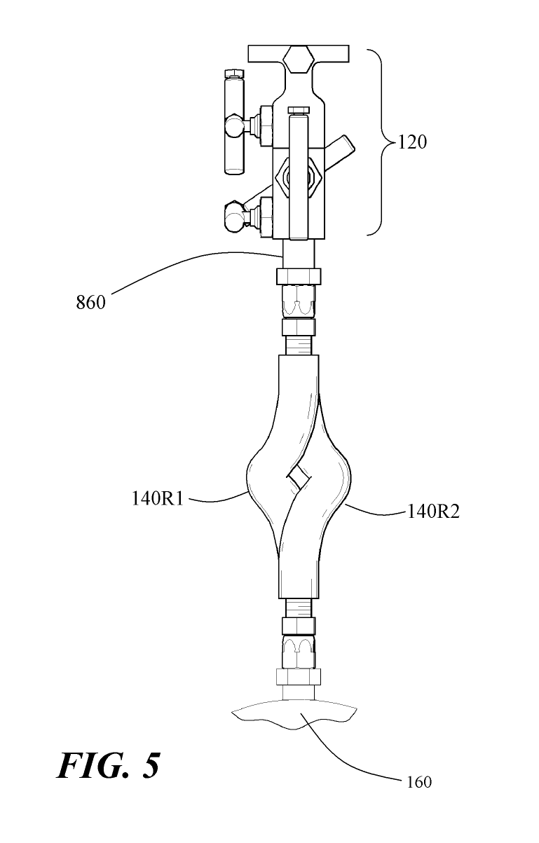

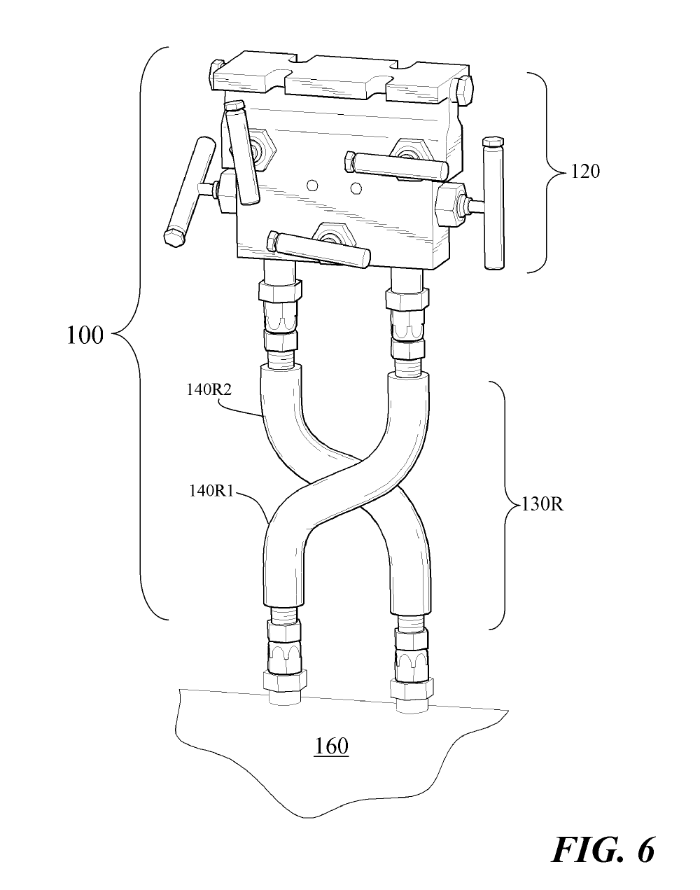

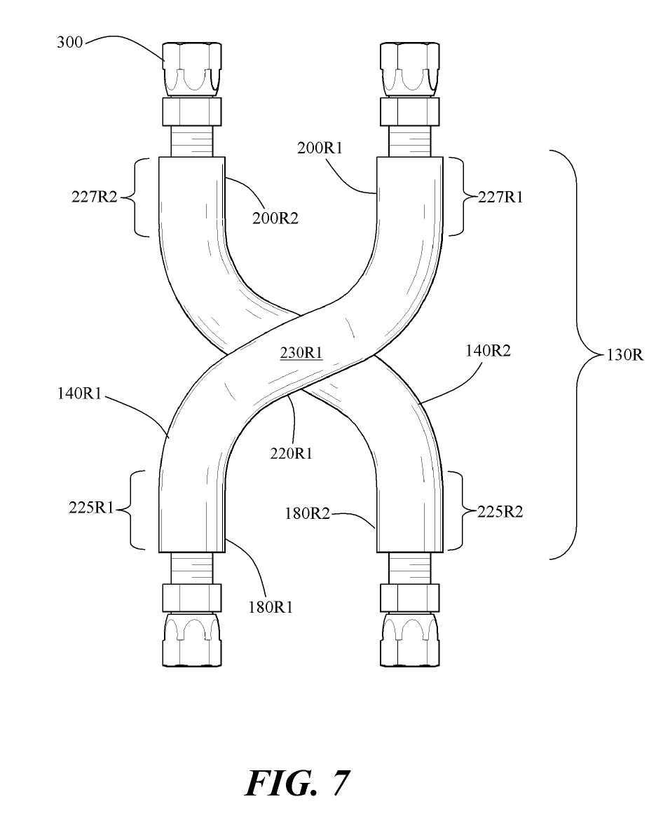

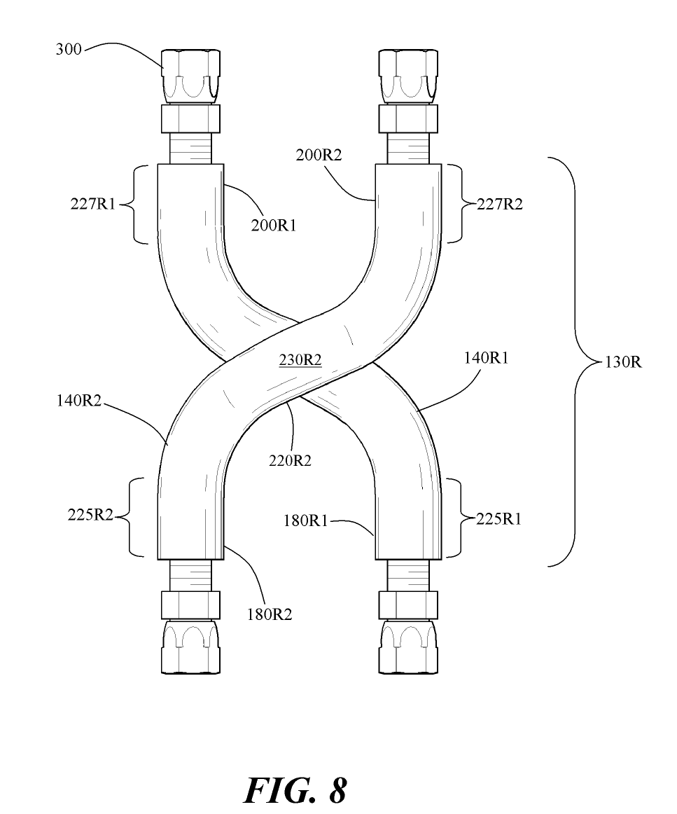

In one embodiment, the crossable rigid pressure lines 130 are a pair of right-handed pipe sections 130R. The pair of right-handed pipe sections 130R comprises first and second right-handed pipe sections 140R1 and 140R2, e.g., as shown in FIG. 1, also see FIGS. 2 through 10. In another embodiment, the crossable rigid pressure lines are left-handed and represented by alpha-numeric label “130L”. The pair of left-handed pipe sections 130L comprise first and second left-handed pipe sections 140L1 and 140L2.

In one embodiment the pipe sections 130R (i.e., right-handed pipe sections 140R1 and 140R2) are essentially identical to each other each having a quarter right-handed helical twist (i.e., a 90° right-handed twist). In another embodiment the pair of left-handed pipe sections 130L (i.e., left-handed pipe sections 140L1 and 140L2) are essentially identical to each other each having a quarter left-handed helical twist (i.e., a 90° left-handed twist).

With respect to the embodiment comprising a pair of crossable rigid pressure lines 130R made up of first and second right-handed pipe sections 140R1 and 140R2. The first right-handed pipe section 140R1 defines a through-bore 145R1 therethrough, lower and upper ends 180R1 and 200R1, and a middle portion 220R1 located between ends 180R1 and 200R1. The middle portion 220R1 defines a partial right-handed helical twist 230R1, i.e., less than a full turn of 360°. The second right-handed pipe section 140R2 defines a through-bore 145R2 therethrough, lower and upper ends 180R2 and 200R2, and a middle portion 220R2 located between ends 180R2 and 200R2. The middle portion 220R2 defines a partial right-handed helical twist 230R2, i.e., less than a full turn of 360°.

Lower and upper ends 180R1 and 200R1 respectively define lower and upper straight portions 225R1 and 227R1. The lower and upper ends 180R1 and 200R1 respectively include lower and upper internal threads 260R1 and 280R1 to enable an engineer or fitter to connect a connecting member 300 to the lower and upper ends 180R1 and 200R1; the connecting members 300 having a complementary external thread. In the alternative, the lower and upper internal threads 260R1 and 280R1 can be replaced with external threads (not shown); and the external threads of the connecting members 300 can be replaced with complementary internal threads.

Lower and upper ends 180R2 and 200R2 respectively define lower and upper straight portions 225R2 and 227R2. The lower and upper ends 180R2 and 200R2 respectively include lower and upper internal threads 260R2 and 280R2 to enable an engineer or fitter to connect a connecting member 300 to the lower and upper ends 180R2 and 200R2; the connecting members 300 having a complementary external thread. In the alternative, the lower and upper internal threads 260R2 and 280R2 can be replaced with external threads (not shown); and the external threads of the connecting members 300 can be replaced with complementary internal threads.

With respect to the embodiment comprising a pair of crossable rigid pressure lines 130L made up of first and second left-handed pipe sections 140L1 and 140L2. The first left-handed pipe section 140L1 defines a through-bore 145L1 therethrough, lower and upper ends 180L1 and 200L1, and a middle portion 220L1 located between ends 180L1 and 200L1. The middle portion 220L1 defines a partial left-handed helical twist 230L1, i.e., less than a full turn of 360°. The second left-handed pipe section 140L2 defines a through-bore 145L2 therethrough, lower and upper ends 180L2 and 200L2, and a middle portion 220L2 located between ends 180L2 and 200L2. The middle portion 220L2 defines a partial left-handed helical twist 230L2, i.e., less than a full turn of 360°.

Lower and upper ends 180L1 and 200L1 respectively define lower and upper straight portions 225L1 and 227L1. The lower and upper ends 180L1 and 200L1 respectively include lower and upper internal threads 260L1 and 280L1 to enable an engineer or fitter to connect a connecting member 300 to the lower and upper ends 180L1 and 200L1; the connecting members 300 having a complementary external thread. In the alternative, the internal threads 260L1 and 280L1 can be replaced with external threads (not shown); and the external threads of the connecting members 300 can be replaced with complementary internal threads.

Lower and upper ends 180L2 and 200L2 respectively define lower and upper straight portions 225L2 and 227L2. The lower and upper ends 180L2 and 200L2 respectively include lower and upper internal threads 260L2 and 280L2 to enable an engineer or fitter to connect a connecting member 300 to the lower and upper ends 180L2 and 200L2; the connecting members 300 having a complementary external thread. In the alternative, the internal threads 260L2 and 280L2 can be replaced with external threads (not shown); and the external threads of the connecting members 300 can be replaced with complementary internal threads.

It will be understood by a person of ordinary skill in the art of helices that a right-handed helix is one where the line of sight being the helical axis, if clockwise movement of the helix corresponds to axial movement away from the observer, then it is called a right-handed helix; but if counter-clockwise movement corresponds to axial movement away from the observer, it is a left-handed helix.

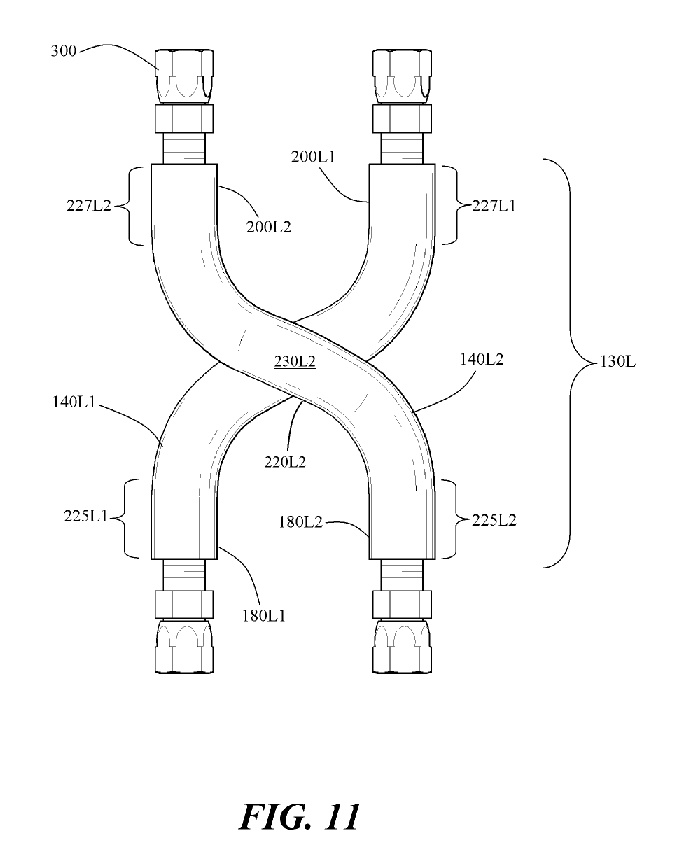

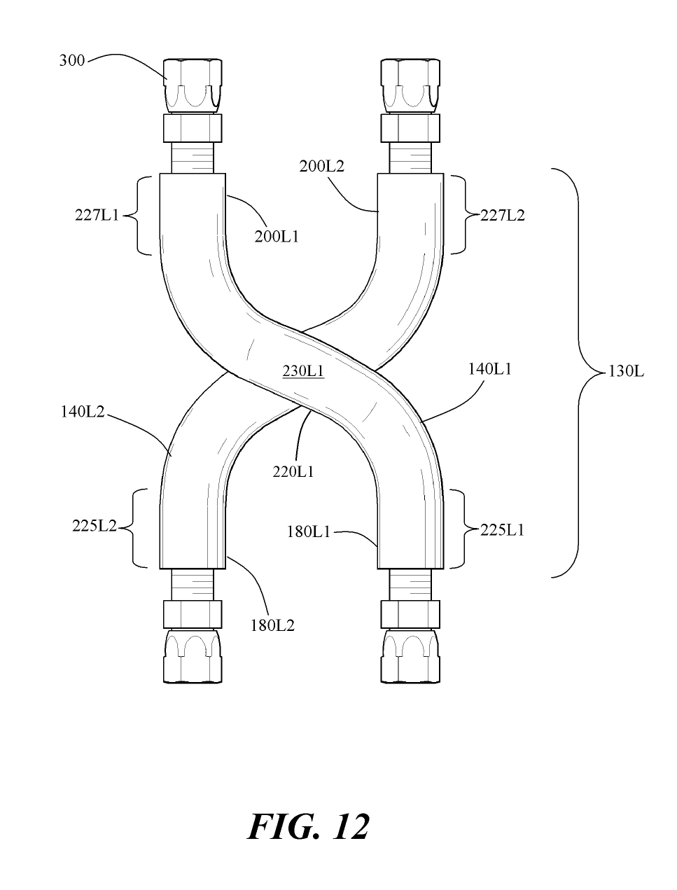

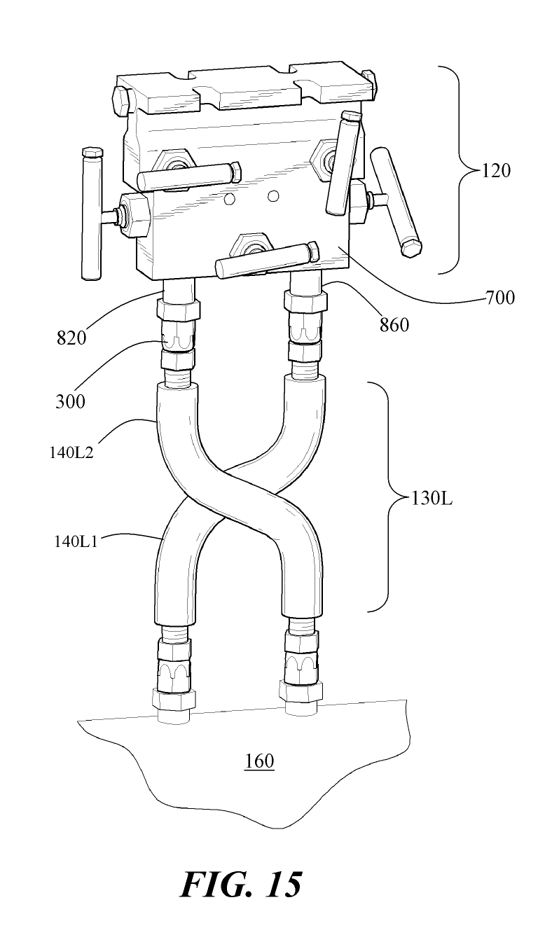

FIG. 1 shows a perspective non-limiting environmental view of the mounting system 100. A valve isolation assembly 120 is shown attached to a pair of right-handed crossable rigid pressure lines 130R, and more specifically to the upper ends 200R1 and 200R2 of first and second right-handed pipe sections 140R1 and 140R2, respectively. The first and second pipe sections 140R1 and 140R2 are shown attached to a meter tube 160. The terms “meter tube”, “meter pipe”, and “meter pipework” are regarded hereinafter as equivalent terms. The word “rigid” as used in this paragraph is intended to mean that the first and second pipe sections 140R1 and 140R2 are sufficiently rigid to support the valve isolation assembly 120 without deformation of their overall shape and/or compromising the diameter of the pipe bores 145R1 and 145R2 (with respect to first and second right-handed pipe sections 140R1 and 140R2) or compromising the diameter of the pipe bores 145L1 and 145L2 (with respect to first and second left-handed pipe sections 140L1 and 140L2, e.g., see FIGS. 11 through 15).

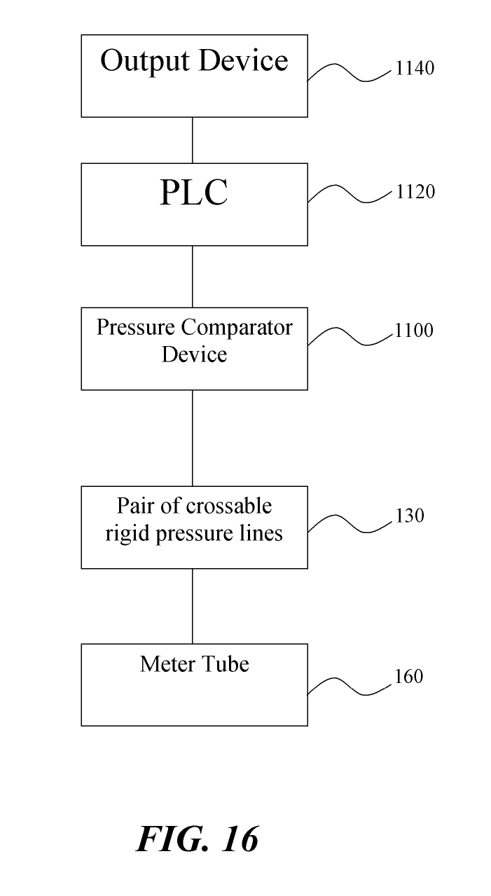

During typical operation in the field the first and second outlet pressure ports of the valve isolation assembly 120 are operably coupled to a pressure comparator 1100 (see, e.g. FIGS. 1 and 16). The pressure comparator 1100 is operationally linked to a programmable logic controller (PLC) 1120 (shown in FIG. 16). The PLC 1120 is typically located inside an instrument box such as instrument box 1125. Output from the PLC 1120 can be sent to any suitable kind of output device 1140 such as, but not limited to, a digital display screen located on or inside the instrument box 1125, a wireless transmitter for wirelessly broadcasting an output signal to a remote control station (not shown). The pressure comparator 1100 typically comprises one or two diaphragms (not shown).

An example of an instrument box for analyzing and reporting flow data is “TOTALFLOW”™, an instrumentation box supplied by ABB Inc. (“Totalflow Products”) located at 7051 Industrial Blvd., Bartlesville, Okla. 74006 (Tel: 918-338-4888, Fax: 918-338-4699).

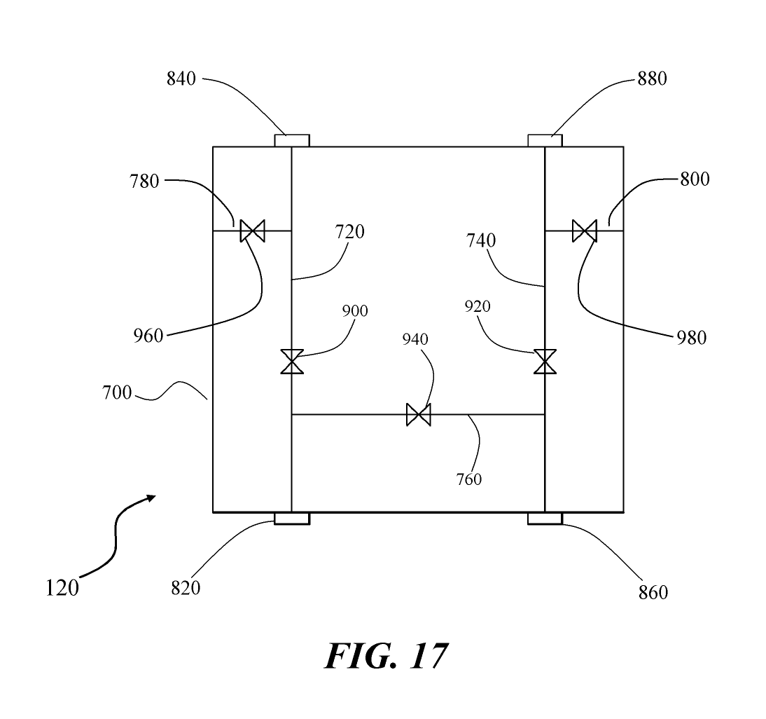

Referring to FIGS. 1 through 6 and 15-17 of which FIG. 17 shows a schematic layout of the valve isolation assembly 120. The valve isolation assembly 120 is made up of a rigid manifold structure 700 made out of any suitable material such as a metal allow. For example, the rigid manifold 700 can be constructed out of stainless steel which is corrosion resistant. The manifold 700 can be made using traditional metal forming methods such as casting and machining.

FIG. 17 shows a schematic of the manifold 700. The manifold defines interior channels made up of first and second through-channels 720 and 740, respectively; equalization channel 760; and first and second vent channels 780 and 800. Inlet and outlet pressure ports 820 and 840 are respectively located at opposite ends of first through channel 720; and inlet and outlet pressure ports 860 and 880 are located at opposite ends of the second through channel 740. First and second isolation valves 900 and 920 are respectively located in first and second through-channels 720 and 740; and an equalization valve 940 is located in the equalization channel 760. First and second vent valves 960 and 980 are respectively located in first and second vent channels 780 and 800; and first and second vent channels 780 and 800 are respectively connected to first and second through-channels 720 and 740.

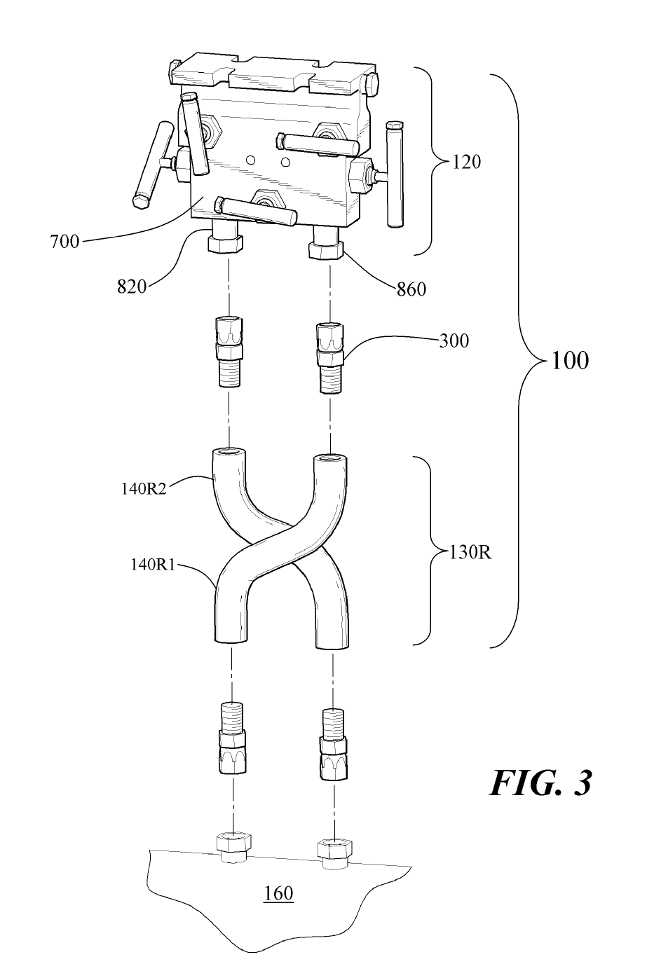

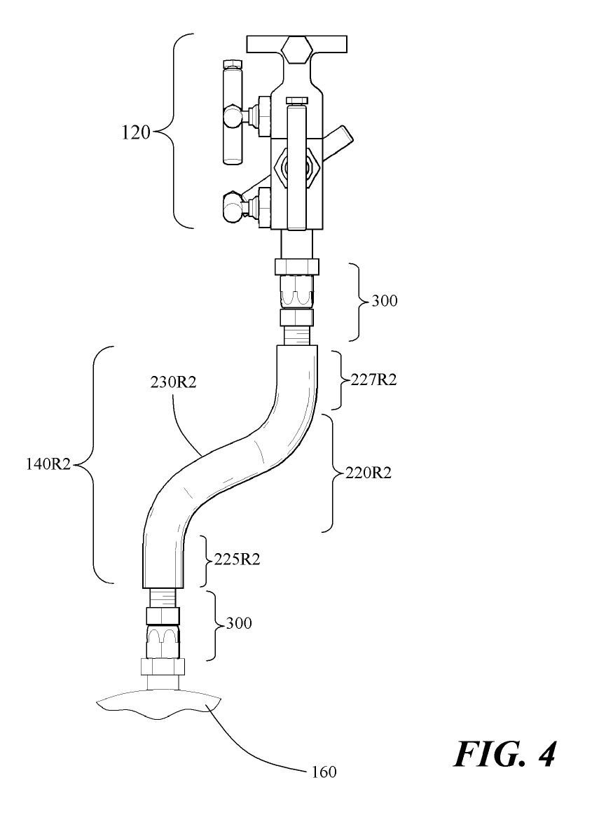

It should be understood that any suitable valve isolation assembly can be used such as, but not limited to, the valve isolation assembly shown in FIGS. 3 and 4 in U.S. Pat. No. 6,484,587 (shown as part number “62” in FIGS. 3 and 4 of U.S. Pat. No. 6,484,587). U.S. Pat. No. 6,484,587 is incorporated herein by reference in its entirety.

In normal use the first and second inlet pressure ports 820 and 860 are in operable fluid contact with a meter tube 160 via a pair of pipe sections 130R or 130L; and the first and second outlet pressure ports 840 and 880 are operatively coupled to a pressure comparator device 1100 such as a single or double diaphragm device, which in turn is operatively connected to an electrical circuit (represented by numeric label “164” in U.S. Pat. No. 6,484,587). The electrical circuit can be made up of a programmable logic controller (PLC) 1120 itself operatively linked to an output device 1140 (see schematic layout shown in FIG. 16).

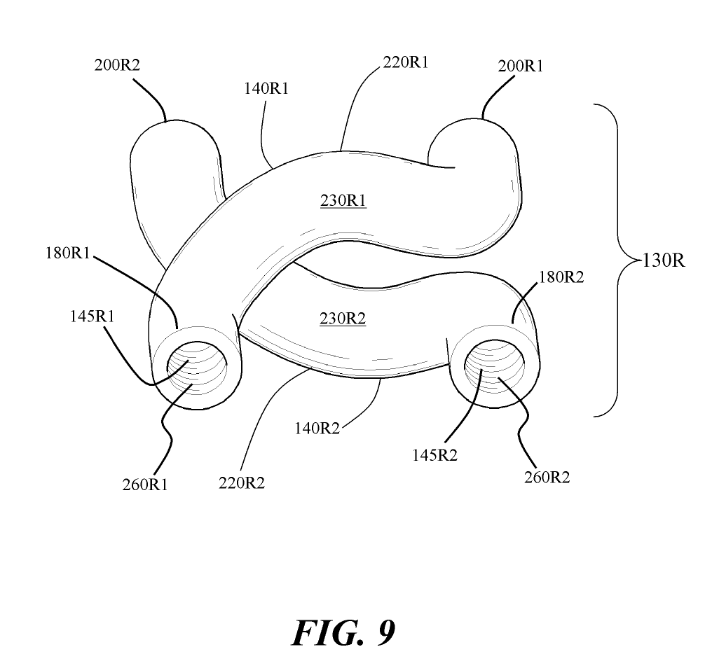

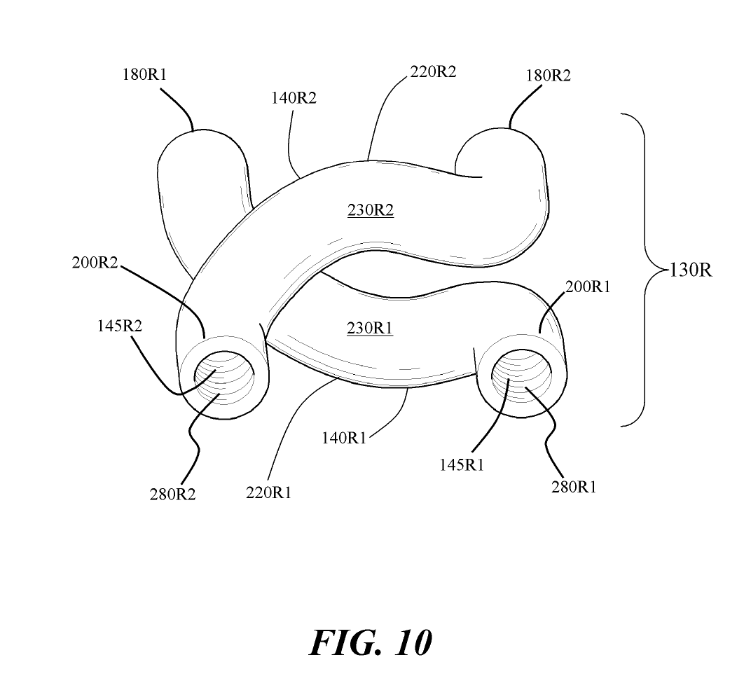

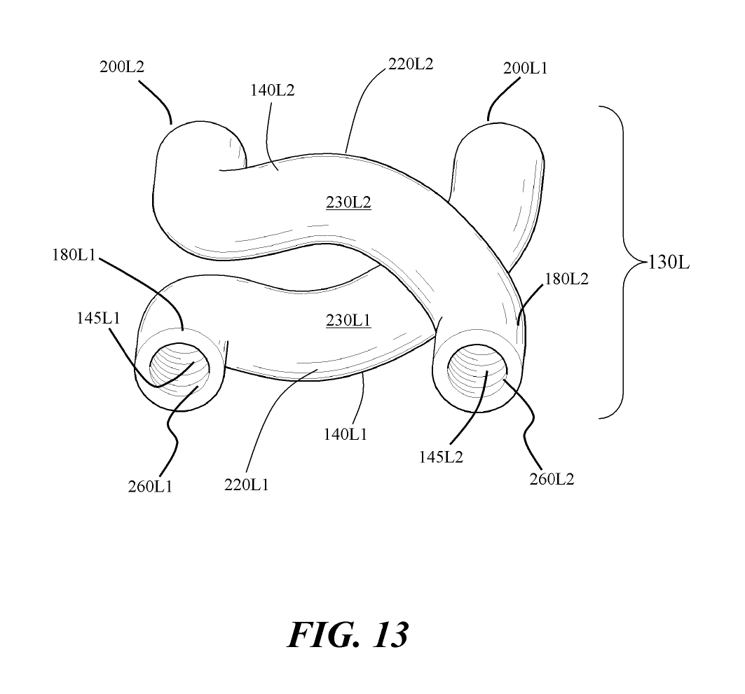

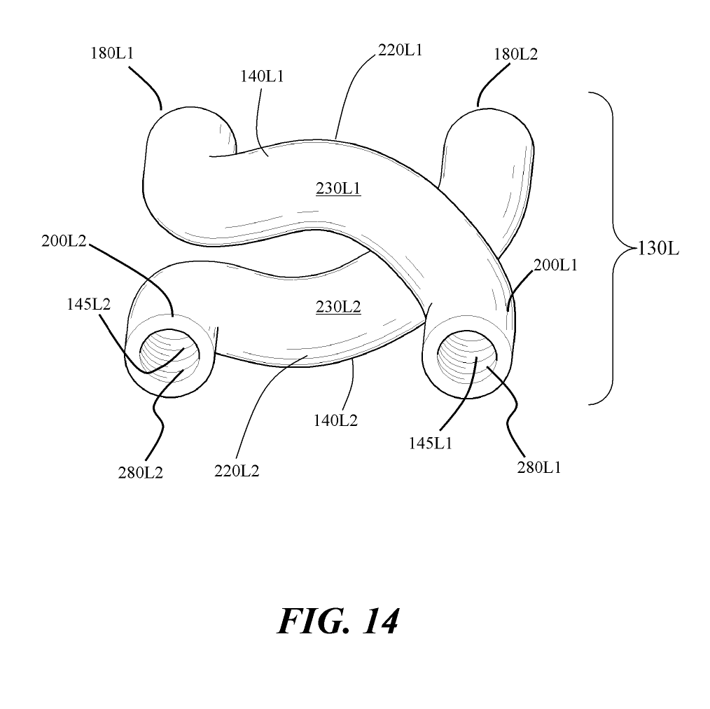

In one embodiment the invention comprises a pair of crossable pressure lines; for example, right-handed pipe first and second pipe sections 140R1 together with 140R2 as shown in FIGS. 9 and 10; or left-handed pipe first and second pipe sections 140L1 together with 140L2 as shown, for example, in FIGS. 13 and 14.

The invention being thus described, it will be evident that the same may be varied in many ways by a routineer in the applicable arts. Such variations are not to be regarded as a departure from the spirit and scope of the invention and all such modifications are intended to be included within the scope of the claims.

I claim:

1. A mounting system, comprising:
a valve isolation assembly comprising first and second inlet ports and first and second outlet ports; and
a pair of crossable pressure lines made up of first and second pipes, the first and second pipes respectively defining first and second upper ends and first and second lower ends, first and second pipes respectively defining first and second middle portions, the upper ends of each first and second pipes are operably coupled to the first and second inlet ports of the valve isolation assembly, the first and second middle portions each defining a quarter right-handed helix turn.

2. A mounting system, comprising:
a valve isolation assembly comprising first and second inlet ports and first and second outlet ports; and
a pair of crossable pressure lines made up of first and second pipes, the first and second pipes respectively defining first and second upper ends and first and second lower ends, first and second pipes respectively defining first and second middle portions, the upper ends of each first and second pipes are operably coupled to the first and second inlet ports of the valve isolation assembly, the first and second middle portions each defining a quarter left-handed helix turn.

3. A pair of crossable pressure lines, comprising:
first and second pipes, the first and second pipes respectively defining first and second upper ends and first and second lower ends, first and second pipes respectively defining first and second middle portions, the upper ends of each first and second pipes are operably coupled to the first and second inlet ports of the valve isolation assembly, the first and second middle portions each defining either a quarter right-handed helix turn or a quarter left-handed helix turn.
